(19) United States
(12) Patent Application Publication
(10) Pub. No.: US 2011/0113006 A1
(43) Pub. Date: May 12, 2011

(54) BUSINESS PROCESS CONTROL APPARATUS, BUSINESSES PROCESS CONTROL METHOD AND BUSINESS PROCESS CONTROL PROGRAM

(76) Inventors: Motohiko Sakaguchi, Tokyo (JP); Hidekazu Sakagami, Tokyo (JP)

(21) Appl. No.: 12/736,725

(22) PCT Filed: Apr. 9, 2009
(86) PCT No.: PCT/JP2009/057257

§ 371 Date: Jan. 5, 2011

(30) Foreign Application Priority Data
May 8, 2008 (JP) 2008-121985

(51) Int. Cl. G06F 17/30

(52) U.S. Cl. 707/602; 707/E17.005

(57) ABSTRACT

A business process control apparatus, a business process control method and a business process control program are provided which can properly estimate a business process. The business process control apparatus includes: business process data storage means for storing a business process data group; copying means for copying business process data contained in said business process data group and adding new business process data to said business process data group; and estimation calculating means for calculating an estimation value indicating how much said business process data is effective.

### TECHNICAL FIELD

The present invention relates to a business process control apparatus, a business process control method and a business process control program.

### BACKGROUND ART

A business process control apparatus is widely known to improve an efficiency of a business. In the business process control apparatus, data on a business to be controlled are stored as business process data. In the business process data, one business is dissolved into at least one process (working item: hereinafter, to be referred to as a “task”) and defined by it. A user progresses an actual business and inputs data of a progress situation and a result of each task into the business process control apparatus. The inputted data is reflected to the business process data. By referring to the business process data, the progress situations of a whole and part of the business processes are grasped at the same time. Also, whether or not the business has been accomplished by an effective process can be known. If the business process data is accumulated each time the business process is executed, it is possible to know a task to be improved when a new business is started.

As a related technique, Japanese Patent Publication (JP 2007-264908A) is known, which discloses the following technique. That is, a work having a type of a result identical to a type of a result of an analysis target work is searched, and work efficiency is determined based on a work quantity and result quantity of the searched work. A reference efficiency is determined based on at least one work efficiency and then a difference between the work quantity of the analysis target work and a work quantity when the analysis target work is performed in the reference efficiency, is calculated as a work improvement effect. Thus, it becomes possible to preferentially improve an individual work with a high improvement effect prediction value among the individual works of the whole of business.

When a new business is started, it is effective to consider the business process data in businesses performed in past. The techniques related to a method of generating new business process data on the basis of the past business process data is described in Japanese Patent Publications (JP 2007-233474A, JP-A-Heisei 10-105540, and JP 2007-41674A).

Also, if a newly performed business is same as a previously performed business in contents, new business process data can be generated easily by copying the past business process data. The techniques related to a method of copying data are described in Japanese Patent Publications (JP-A-Heisei 5-324438 and JP-A-Heisei 8-22409).

### Citation List:

[Patent Literature 1]: JP 2007-264908A
[Patent Literature 2]: JP 2007-233474A
[Patent Literature 3]: JP-A-Heisei 10-105540
[Patent Literature 4]: JP 2007-41674A
[Patent Literature 5]: JP-A-Heisei 5-324438
[Patent Literature 6]: JP-A-Heisei 8-22409

### SUMMARY OF THE INVENTION

It is preferable to statistically grasp results in past businesses when a new business is started. For example, it is supposed that a business process with an identical content is executed plural times. In this case, whether or not the business process is effective could be determined based on not the business process result for one time but the businesses process results for plural times.

In the business, there are a routine work process and a transient work process. In the routine work process, whether or not the business process data are identical to each other can be relatively easily known by referring to a name of the business work process, for example. On the other hand, in the transient work process, even if business work processes have the same content, the names of them are of a variety, depending on a user. For this reason, in the transient work process, it is difficult to know whether or not past business work processes are identical to each other in content. Thus, it is hard to statistically know the results of the past business work processes.

Therefore, an object of the present invention is to provide a business process control apparatus, a business process control method, and a business process control program, which whether or not the business processes are identical to each other in content can be easily determined even in the transient work processes.

The business process control apparatus according to the present invention includes: a business process data storage section for storing a business process data group; a copying section for copying a business process data included in the business process data group in response to an instruction from a user; and an estimation calculating section for calculating an estimation value, which indicates an effective degree of the business process data, on the basis of the number of times that the business process data is copied by the copying section.

The business process control method according to the present invention includes: a step of copying the business process data included in a business process data group, in response to an instruction from the user; and a step of calculating the estimation value, which indicates the effective degree of the business process data, on the basis of the number of times of copy of the business process data in the copying step.

The business process control program according to the present invention is a program for attaining the business process control method through the use of a computer.

According to the present invention, the business process control apparatus, the business process control method and the business process control program are provided, in which whether or not the businesses are identical to each other in content can be easily known, even in the transient work process.

### BRIEF DESCRIPTION OF THE DRAWINGS

FIG. 1 is a block diagram showing the configuration of a business process control apparatus according to the present invention;

FIG. 2 is a conceptual diagram showing business process data;

FIG. 3 is a conceptual diagram showing task data;

FIG. 4 is a conceptual diagram showing relational data;

FIG. 5 is a conceptual diagram indicating user estimation data;

FIG. 6 is a conceptual diagram showing setting data;

FIG. 7 is a diagram showing a business process registration display image;

FIG. 8 is a diagram showing a business process detail display image;

FIG. 9 is a diagram showing a task registration display image;

FIG. 10 is a diagram showing a display image to urge an estimation input of a business process;

FIG. 11 is a diagram showing a business process retrieval display image;

FIGS. 12A and 12B are a flowchart showing a business process control method;

FIG. 13 is a conceptual diagram showing an identical business process data group; and

FIG. 14 is a conceptual diagram showing a calculation result of an estimation value.

### DESCRIPTION OF EMBODIMENTS

The present invention will be described below in detail with reference to the attached drawings.

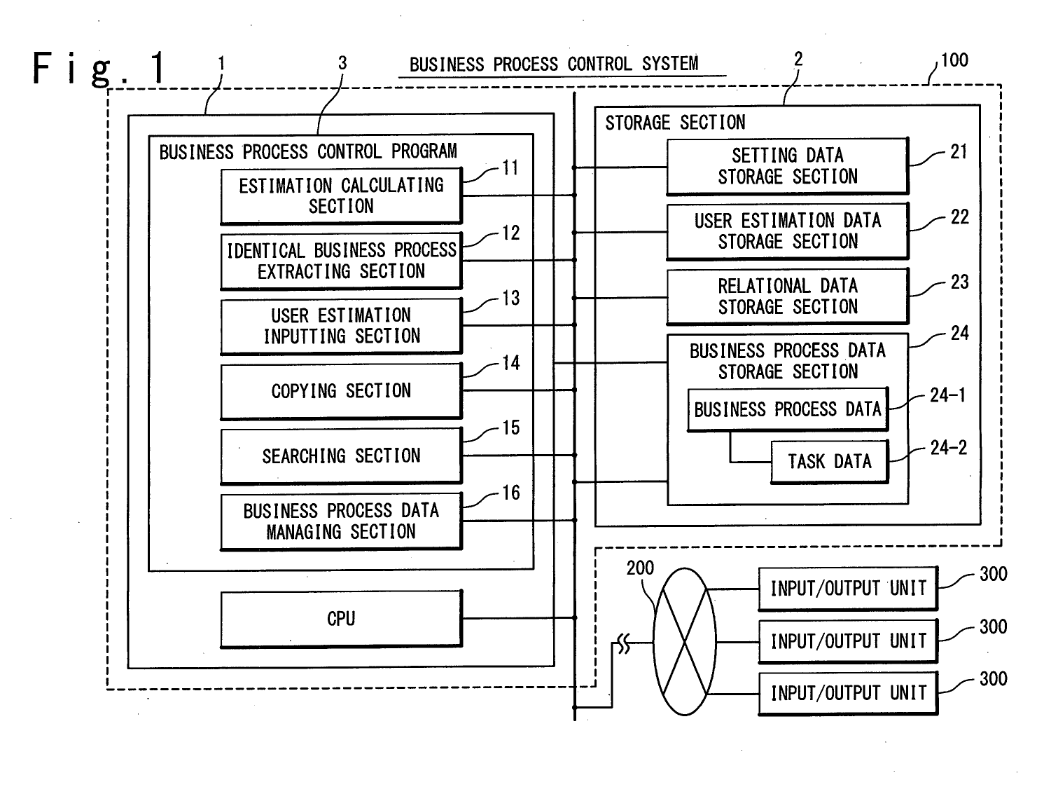

FIG. 1 is a functional block diagram showing a configuration of a business process control system according to an exemplified embodiment of the present invention. The business process control system includes a business process control apparatus 100, one or more input/output units 300 and a communication line 200. The business process control apparatus 100 is connected through the communication line 200 to one or more input/output units 300.

The input/output unit 300 is operated by a user (such as a manager of business processes and a person in charge of one business process). The input/output unit 300 includes an input function for the user to input data into the business process control apparatus 100 and an output function for the business process control apparatus 100 to output data to the user. In this exemplified embodiment, the input/output unit 300 includes a display unit. Data from the business process control apparatus 100 is assumed to be notified to the user through the display unit. As the input/output unit 300, typically, a personal computer, a note-type personal computer, a mobile equipment, an STB (Set-Top BOX), a mobile telephone, PHS and PDA (Personal Digital Assistants) are exemplified.

As the communication line 200, it is possible to use a conventional public line, commercial line or dedicated line.

The business process control apparatus 100 is an apparatus for managing the business process data. The business process control apparatus 100 includes a storage section 2 for storing various data such as business process data, and a control section 1 for managing the business process data.

The control section 1 includes a CPU, a ROM (Read Only Memory) and a RAM (Random Access Memory). The control section 1 attains functions when a business process control program stored in the ROM is executed by the CPU.

At first, data stored in the storage section 2 will be described in detail. The storage section 2 includes a setting data storage section 21, a user estimation data storage section 22, a relational data storage section 23 and a business process data storage section 24.

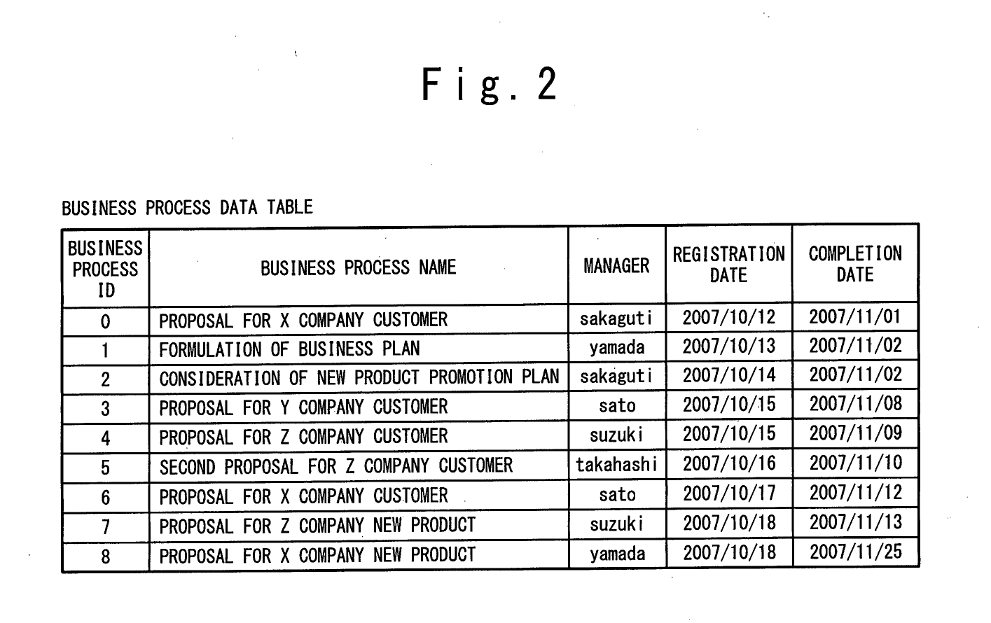

In the business process data storage section 24, a plurality of business process data are stored in a form of a table (hereinafter, a business process data table). FIG. 2 shows one example of the business process data table. As shown in FIG. 2, each of the plurality of business process data includes a business process ID to identify a business process, a name of the business process, a name of a manager of the business process, a registration date indicating a date of registration in the business process control apparatus 100, and a completion date indicating a date on which the business process is completed.

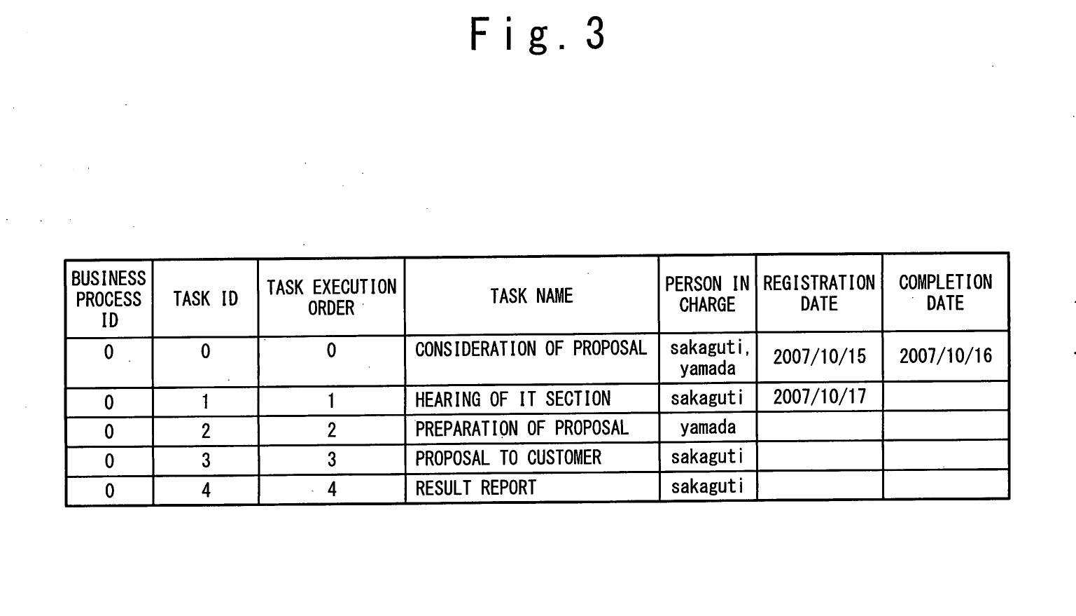

Also, each business process data includes a task data that indicates a task contained in a business process. FIG. 3 is a conceptual diagram showing one example of the task data. As shown in FIG. 3, the task data includes a business process ID to identify the business process to which the task belongs, a task ID to identify the task, an execution order of the task, a task name, a name of a person in charge, a registration date indicating a date on which the task data is registered, and a completion date indicating a date on which the task is completed.

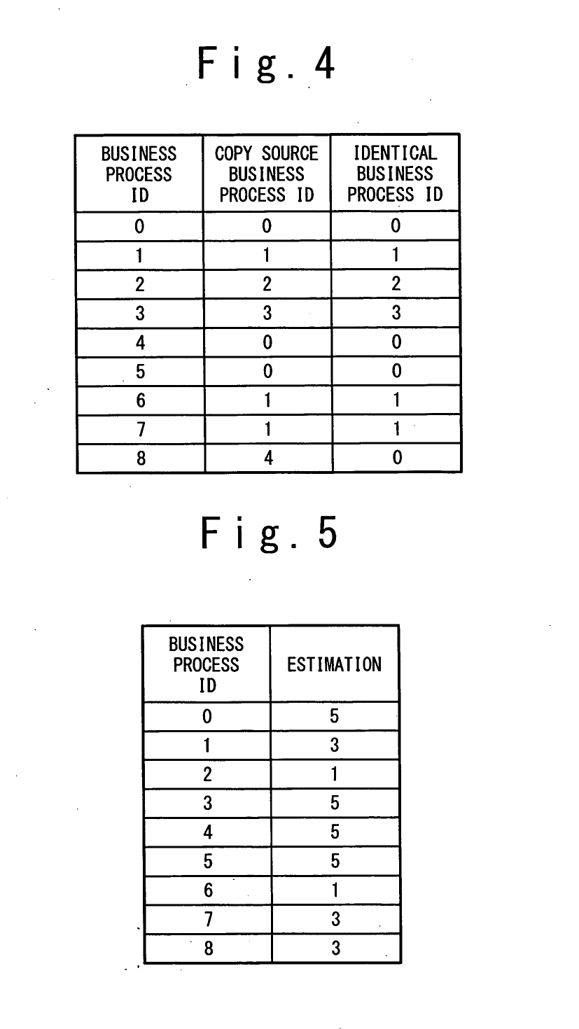

With reference to FIG. 4, the relational data storage section 23 will be described below. In the relational data storage section 23, relational data are stored. The relational data indicates the business process data that are identical to each other in content.

Specifically, the relational data relates a business process ID to a business process ID of a copy source and an identical business process ID.

The business process ID of the copy source indicates what the business process data is copied from. For example, in the business process data with the business process ID of “4”, a copy source business process ID is “0”. That is, the business process data with the ID of “4” indicates that it is copied from the business process data with the ID of “0”.

The identical business process ID indicates which of business process data the business process data with an identical business process ID is substantially identical to. For example, in the business process data with the ID of “8”, the identical business process ID is “0”. That is, the business process data with the IDs of “8” and “0” are substantially identical to each other in content. It should be noted that in the business process data with the ID of “8”, the copy source business process ID is “4”. Thus, the business process data with the ID of “8” is copied from the business process data with the ID of “4”. The business process data with the ID of “4” is copied from the business process data with the ID of “0”. As a result, the business process data with the ID of “8” is identical to the business process data with the ID of “0”.

With reference to FIG. 5, the user estimation data storage section 22 will be described below. The user estimation data storage section 22 stores a user estimation data. The user estimation data indicates an estimation result of the business process by the user. As shown in FIG. 5, the user estimation data indicates a correspondence relation between the business process ID and the estimation result by the user. In this example in FIG. 5, the estimation result is indicated in five stages. The business process data with the ID of “0” is estimated to be meaningful because the estimation result indicates “5”. On the contrary, the business process data with the ID of “2” is estimated to be reluctant because the estimation result is “1”.

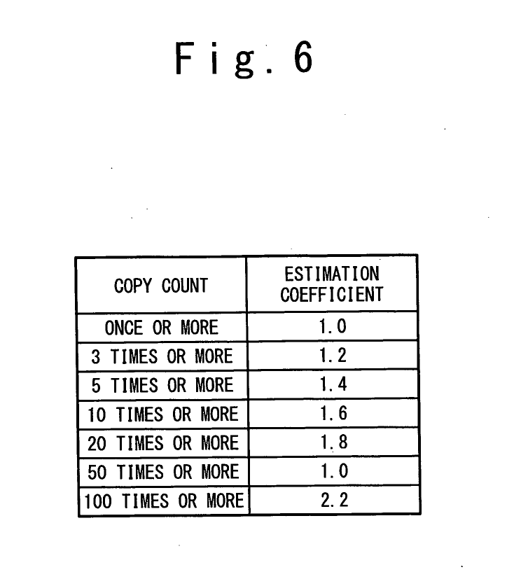

With reference to FIG. 6, the setting data storage section 21 will be described below. The setting data storage section 21 stores a setting data. The setting data indicates a correspondence relation between the number of times of copy and an estimation coefficient. The estimation coefficient is a setting value used when an estimation value of the business is calculated. In the example in FIG. 6, when the number of times of copy is great, a high estimation coefficient is used.

Subsequently, the configuration of the control section 1 will be described in detail.

The control section 1 includes an estimation calculating section 11, an identical business process extracting section 12, a user estimation inputting section 13, a copying section 14, a searching section 15 and a business process data managing section 16. The control section 1 operates as follows.

In response to an instruction from the user, the copying section 14 copies an already stored business process data to generate new business process data in the business process data table. At this time, the copying section 14 generates the relational data that indicates the correspondence relation between the new business process data and the business process data of the copy source and stores it in the relational data storage section 23. The new business process data is managed by the business process data managing section 16. The business process data managing section 16 changes the content of the new business process data in response to the instruction from the user or in accordance with a progress degree of the business (the completion of the business process). When the completion of the business process is reflected, the identical business process extracting section 12 determines whether or not the new business process data is identical in content to the business process data of the copy source. When they are identical to each other in content, the new business process data is considered to be substantially identical to the copy source. When they are different in content, the new business process data is considered to be the business process data different from the copy source. In this way, in the business process data table, the business process data that are identical to each other in content are integrated. The integrated business process data are extracted as an identical business process data group. The estimation calculating section 11 calculates an estimation value that indicates how effective the business process is, in units of identical business process data groups. On the basis of the calculated estimation value, how effective the business process is notified to the user. In this way, since the identical business process data group is extracted, the past businesses processes can be statistically estimated even in the transient work process.

The configurations of the respective sections will be described below in detail.

At first, the business process data managing section 16 will be described.

The business process data managing section 16 has a user interface function and manages the business process data on the basis of data inputted by the user. Specifically, the business process data managing section 16 registers the new business process data. Also, in the transient work process, a task is considered to be changed during the execution of the business process. Thus, the business process data managing section 16 can change the already registered business process data as necessary.

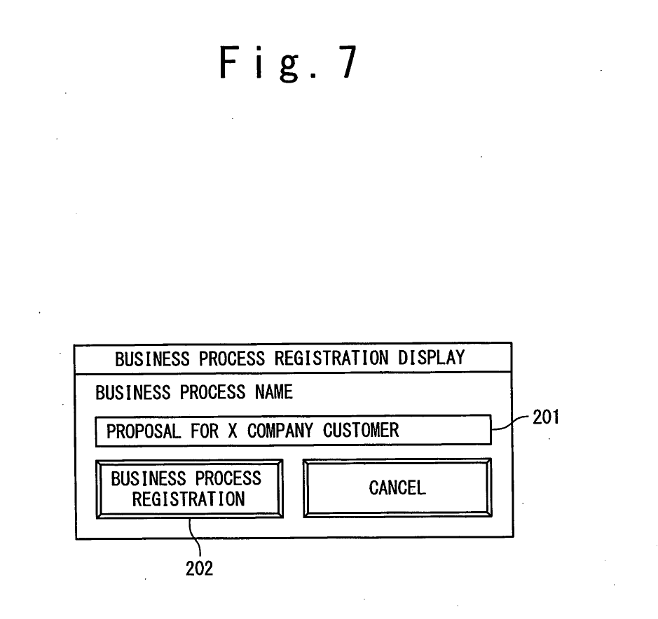

An operation of newly registering the business process data will be described below. In this case, the business process data managing section 16 displays a business process display image on the input/output unit 300. FIG. 7 is a diagram showing the business process display image. The business process display image has a region 201 to which the name of the business process is inputted, and a button 202 of “business process registration”. The user uses a mouth, a keyboard or the like, and inputs a business process name into the region 201. Then, the “business process registration” button 202 is selected. When the button 202 is selected, the business process data managing section 16 generates the new business process data and stores (registers) it in the business process data storage section 24. Moreover, the business process data managing section 16 displays an image to urge an input of task data and urges the user to input the task data. At this time, a list of the tasks generated in advance for each kind of business may be displayed as a template, and the operation for the user to input the task data may be assisted. When the task data is inputted, the business process data managing section 16 reflects the inputted task data on the new business process data.

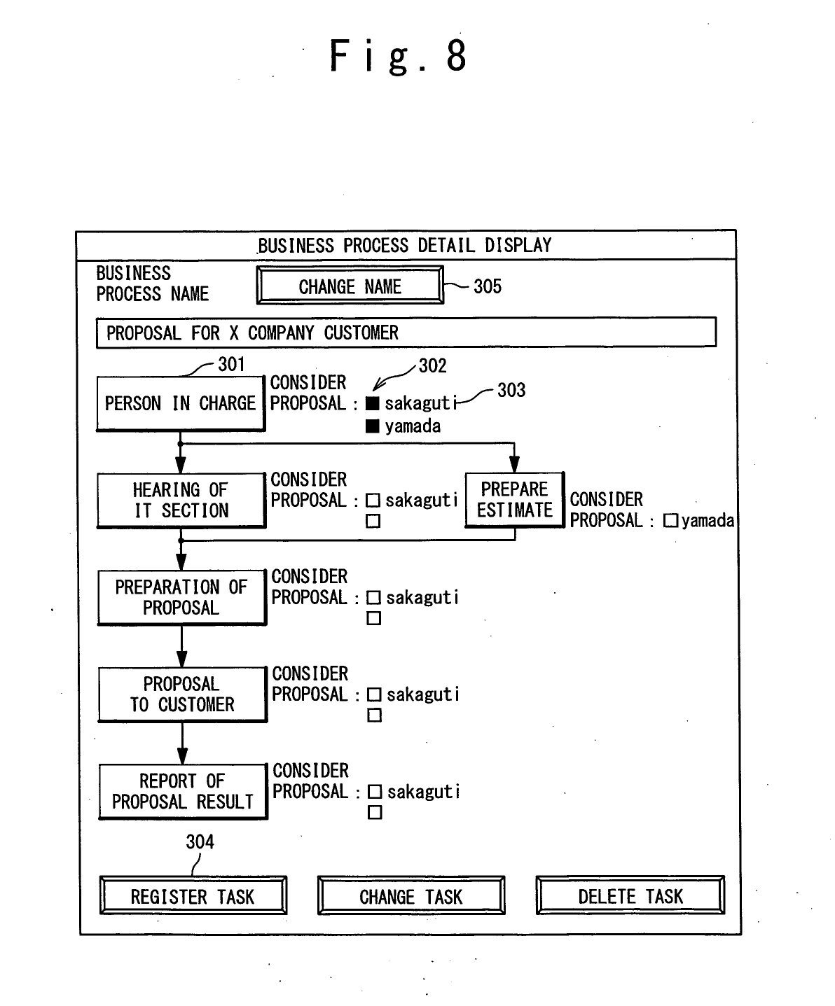

Subsequently, an operation of changing the content of the business process data will be described. In this case, the business process data managing section 16 displays on the input/output unit 300, a business process detail display image indicating the business process data of a change target. FIG. 8 shows one example of the business process detail display image. The business process detail display image shown in FIG. 8 includes a “change name” button 305, a task field 301 indicating a task, a progress situation input field 302, a field 303 of a name of a person in charge and a “register task” button 304.

When the name of the business process data is desired to be changed, the user selects the “change name” button 305. Then, the business process data managing section 16 displays a display image to urge an input of the desired name. When the name is inputted, the business process data managing section 16 reflects the inputted name on the business process data.

Also, when the progress situation is desired to be changed, the user selects the progress situation input field 302. Thus, the progress situation is changed. In the example shown in FIG. 8, a task has been executed up to “consideration of proposal”. Here, it is supposed that a task has been progressed up to “hearing of IT section”. In this case, the user selects the progress situation input field 30.2 displayed on the lateral position of the “hearing of IT section”. Then, the business process data managing section 16 writes a current date and time as the completion date of task data (refer to FIG. 3). Thus, it is reflected that the task has been accomplished up to the “hearing of IT section”. When all of the tasks are completed, the business is considered to be ended. When the business is ended, the business process data managing section 16 writes the current date and time as the completion date of the business process data to reflect the end of the business.

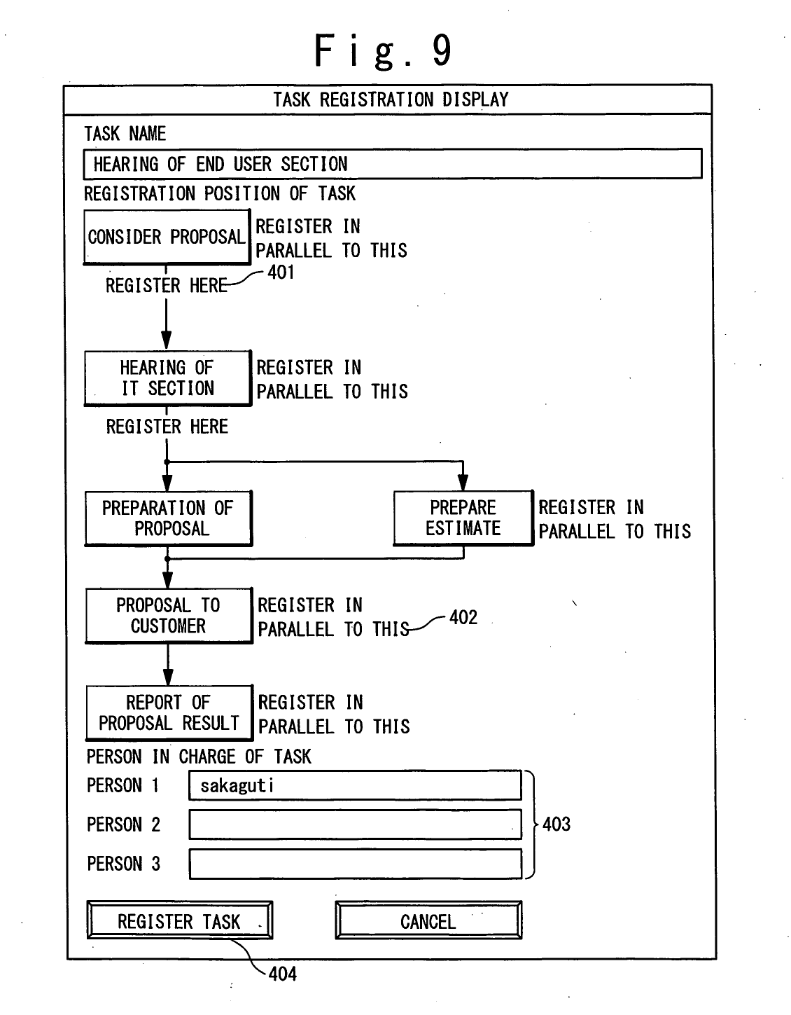

When the addition of a task and the change of a person in charge are desired to be carried out, the user selects the “register task” button 304. Then, the task registration display image is displayed by the business process data managing section 16. FIG. 9 is a diagram showing one example of the task registration display image. The task registration display image includes task registration position input fields (401, 402), person in charge input regions 403 and a “register task” button 404. The task registration position input fields (401, 402) include a “register here” field 401 and a “register in parallel to this” field 402. When a new task is desired to be added, the user selects the filed 401 that is displayed in a position to be desired for the new task to be added. Then, the new task is added to the specified position. Also, when the field 402 is selected, the new task is added in parallel to the already existing task. When the person in charge is desired to be changed, the user specifies a task and inputs a name of a person in charge into the region 403. Therefore, the name of person in charge is changed. Also, when the button 404 is selected, the change point is reflected on the business process data.

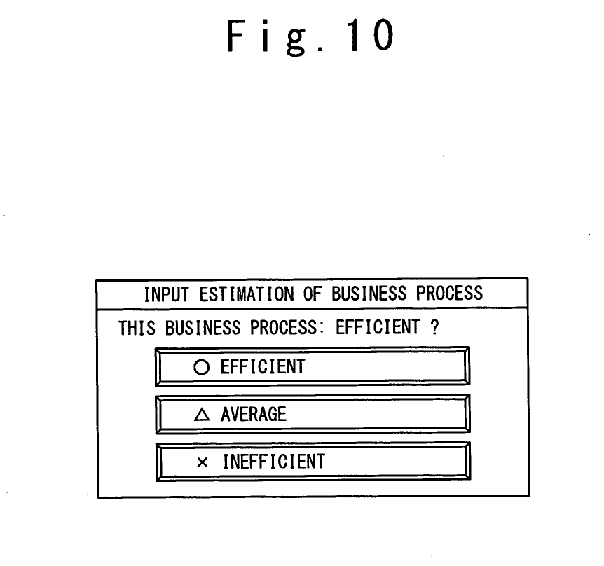

Subsequently, the user estimation inputting section 13 will be described. The user estimation inputting section 13 is provided to receive a result estimated by the user. The user estimation inputting section 13 displays a display image to urge an input of the estimation result of a business, when the business is completed (when the entire progress input field 302 (refer to FIG. 8) is selected). FIG. 10 shows one example of the display image. In this example of FIG. 10, three levels of “∘ efficient”, “Δ average” and “× inefficient” are displayed. This display image is displayed on the input/output unit 300 operated by a manager (business process registration person). Also, it may be displayed on the input/output unit 300 operated by a person in charge of the task. When the user inputs the estimation result in accordance with this display image, the estimation result is related to the corresponding business process ID and stored as the user estimation data (refer to FIG. 5). At this time, the inputted estimation result is converted into a predetermined value and stored. For example, “∘” is converted into “5”, “Δ” is converted into “3”, and “×” is converted into “1”.

Subsequently, the copying section 14 will be described. The copying section 14 copies a specified business process data in response to an instruction from the user, and registers the copy result as new business process data in the business process data table. At this time, the copying section 14 generates a new business process ID, relates the business process ID of the copy source to it and stores as relational data in the relational data storage section 23.

Subsequently, the identical business process extracting section will be described. The identical business process extracting section 12 collects the business process data with a substantially identical content, and extracts as an identical business process data group. The identical business process extracting section 12 refers to the relational data stored in the relational data storage section 23 and collects the business process data with the identical business process ID as the identical business process data group. It should be noted that the identical business process ID is written by the identical business process extracting section 12 at the time of the completion of the business. Specifically, the identical business process extracting section 12 compares the completed business process data with the business process data of the copy source with regard to their contents. Then, if their contents are identical to each other, the same ID as the identical business process ID of the copy source is given as the identical business process ID of the completed business process data.

Subsequently, the estimation calculating section 11 will be described. The estimation calculating section 11 calculates an estimation value of the business process data in units of identical business process data groups. The estimation calculating section 11 calculates the estimation value on the basis of the user estimation data stored in the setting data storage section 21 and the number of times of copy of the business process data. The number of times of copy is summed by referring to the relational data.

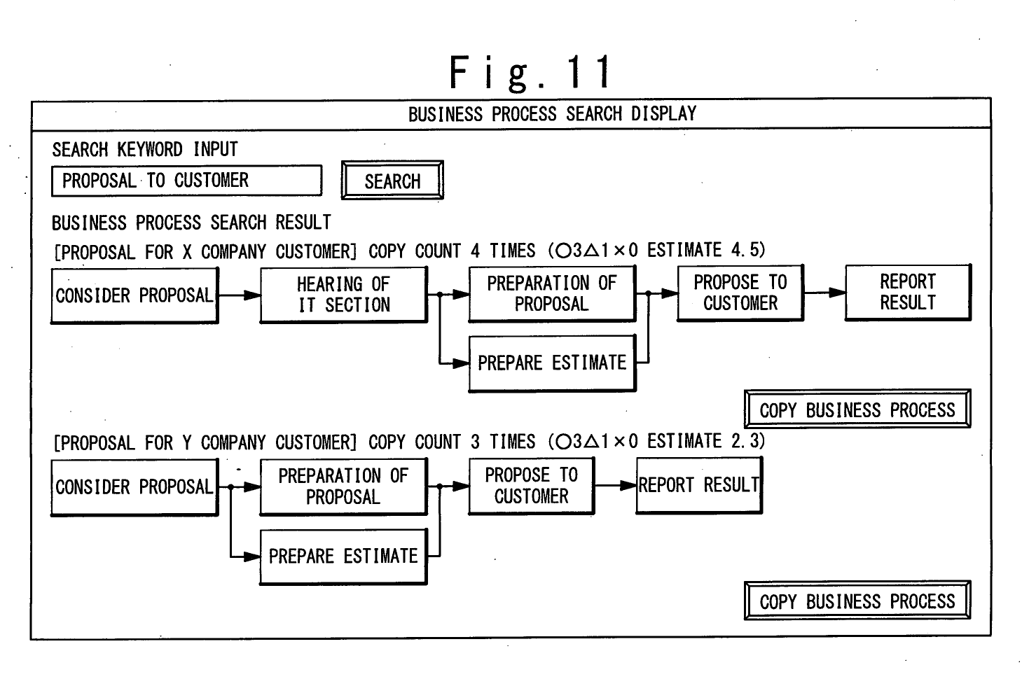

Subsequently, the searching section 15 will be described. The searching section 15 has a function of searching particular business process data from the business process data table. The searching section 15 displays a business process retrieval display image on the input/output unit 300. FIG. 11 is one example showing the business process search display image. As shown in FIG. 11, the business process search display image has a region to urge an input of a search keyword. It is supposed that the user inputs the search keyword into this region and clicks a “search” button. Then, the searching section 15 accesses the business process data storage section 24 and searches the business process data corresponding to the inputted search keyword. The content of the corresponding business process data (a task, and an execution order of the tasks) is displayed on the display unit. Also, the searching section 15 relates the data to the business process data and displays a “copy of business process” button. When the user selects this button, the corresponding business process data is copied by the copying section 14. It should be noted that when the search result is displayed, only the typical business process data (for example, the business process data with the smallest ID) may be displayed from the identical business process data group. Thus, the plurality of business process data with same content are not displayed in parallel. It becomes easy for the user to check the search result. Also, the searching section 15 displays the business process data in order of higher estimation value on the basis of the estimation values calculated by the estimation calculating section 11. In short, they are displayed in order of higher efficiency of the business process. Thus, it becomes easy to reuse the business process data having the high estimation value. Also, as shown in FIG. 11, the number of times of copy and the estimation value may be displayed while they are related to the respective business process data.

Subsequently, the business process control method according to this exemplified embodiment will be described. In this exemplified embodiment, the user can use a copy of the already accumulated business process data, when registering new business process data. Also, the new business process data can be generated without any use of the copy. A case of not using the copy is similar to the above normal process. Thus, the detailed description is omitted.

An operation of using the copy and generating the new business process data will be described below in detail.

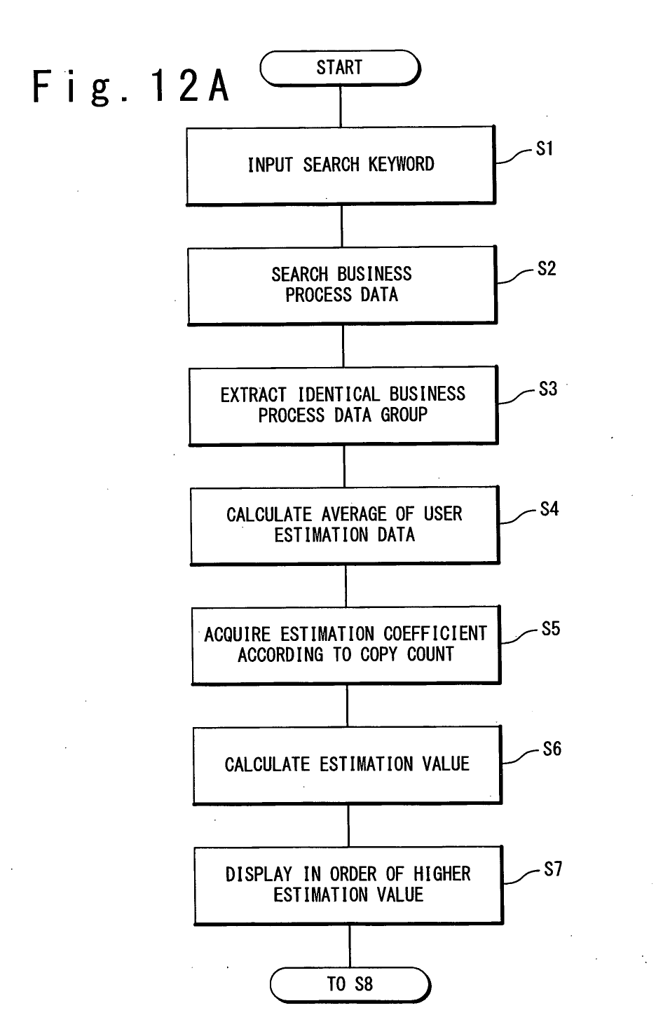

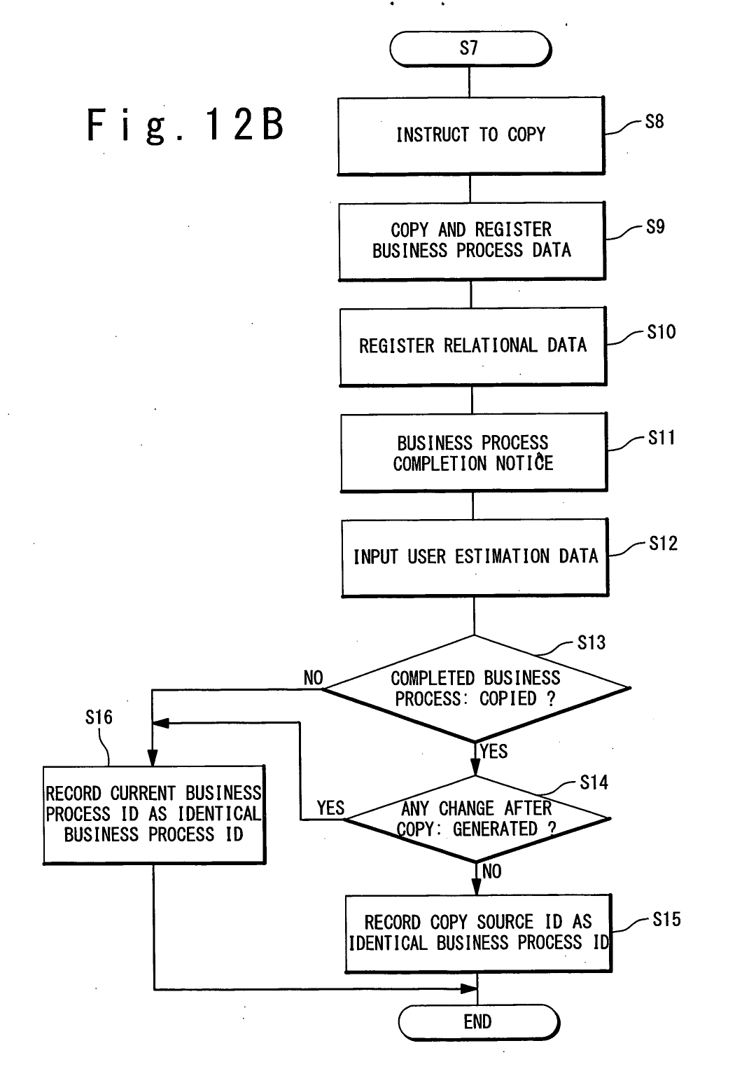

FIGS. 12A and 12B show a flowchart of the business process control method according to the present exemplified embodiment.

### Step S1: Input of Search Keyword

At first, the business process search display image (refer to FIG. 11) is displayed on the input/output unit 300 of a user by the searching section 15. The user inputs a search keyword from the input/output unit 300.

### Step S2: Search of Business Process Data

Next, the searching section 15 refers to the business process data storage section 24 and searches the business process data corresponding to the search keyword. Specifically, a business process name and a task name are compared with the search keyword, and business process data concerned with the search keyword are searched. The searching section 15 obtains an ID of the searched business process data. At the time of the search, for example, if a part of the name matches with the search keyword, it is determined to be concerned.

### Step S3: Extraction of Identical Business Process Data Group

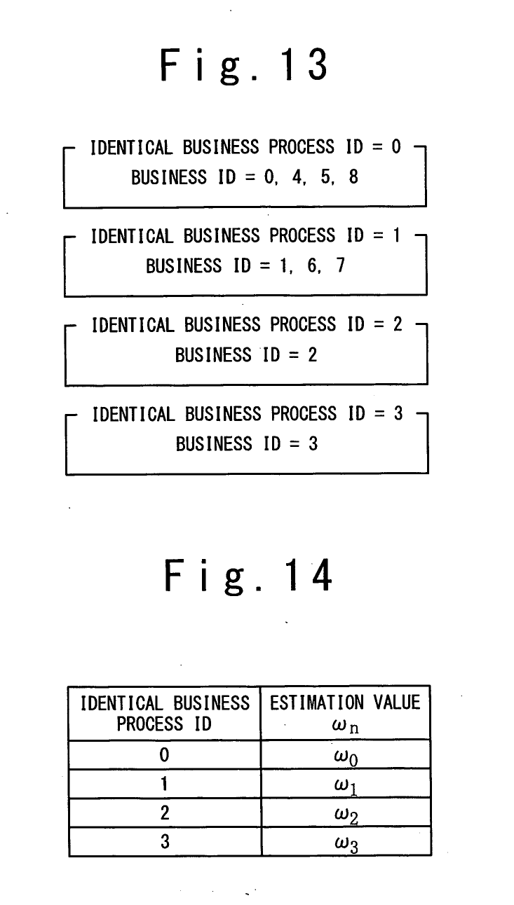

The business process ID obtained at the step S2 is notified as a part of a search result list from the searching section 15 to the identical business process extracting section 12. The identical business process extracting section 12 refers to the relational data of the relational data storage section 23 and converts the business process IDs of the search result list into the identical business process IDs. Also, the identical business process extracting section 12 refers to the business process data table and collects the business process data with the same identical business process ID as the identical business process data group. FIG. 13 is a conceptual diagram showing the identical business process data group. In the example of FIG. 13, the business process data with business process IDs of “0”, “4”, “5” and “8” are collected as one identical business process group. Consequently, the identical business process extracting section 12 determines which of the identical business process data groups is included in the search result. The identical business process extracting section 12 notifies to the estimation calculating section 11, data used to identify the identical business process data group as the search result (identical business process ID) and data used to identify the business process data included in the identical business process data group (business process ID).

Step S4: Calculation of Average Value of User Estimation data

Subsequently, the estimation calculating section 11 refers to the user estimation data storage section 22 and acquires results estimated by the user for the respective business process data included in the notified identical business process data group. Here, when a plurality of users input the estimation results for one business process data, there are a plurality of estimation results for one business process data. In such a case, for example, an average value of the plurality of estimation results is used as an estimation result for the business process data. Moreover, when the notified identical business process data group includes the plurality of business process data, the estimation calculating section 11 calculates an average value of the user estimation results in the identical business process data group. Then, the calculation result is determined as the user estimation value of the identical business process data group.

### Step 5: Acquisition of Estimation Coefficient for Number of Times of Copy

Moreover, the estimation calculating section 11 refers to the relational data of the relational data storage section 23 and sums the number of times of copy in the identical business process data group. Then, the estimation calculating section 11 refers to the setting data (FIG. 5) of the setting data storage section 23 and acquires an estimation coefficient for the number of times of copy. For example, in the example of FIG. 5, when the summed number of times of copy is 60, the estimation coefficient is 2.0.

### Step S6: Calculation of Estimation Value

Moreover, the estimation calculating section 11 multiplies the user estimation value determined at the step S4 by the estimation coefficient acquired at the step S5 to calculate an estimation value (Wn) in the identical business process data group. Consequently, as exemplified in FIG. 14, the correspondence relation between the ID of the identical business process group and the estimation value (Wn) is generated.

The estimation value Wn calculated thus reflects the number of times of copy of the business process data. As the business process data is more meaningful, namely, as the business process is more excellent, the business process data is used by more users, and the number of times of copy tends to increase. In the routine work process, the estimations for the past businesses can be estimated relatively easily, for example, on the basis of production amounts in many cases. On the other hand, in the transient work process, it is difficult to estimate the effectiveness of the past businesses. For example, in a business for proposal of a new product, unless the content of the proposal is excellent even if the entire business is completed in a short time, the business cannot be said to be excellent. If an estimations of the past businesses are difficult, whether it should be improved or kept in an actual state cannot be determined. Thus, it is difficult to reflect the contents of past businesses on a new business. As described in the present exemplified embodiment, by reflecting the number of times of copy on the estimation value Wn, the validity can be estimated even for the business whose estimation is difficult, as in the transient work process.

### Step S7: Display in Order of Higher Evaluation Value

The correspondence relation between the identical business process group and the estimation value Wn, which is calculated at the step S6, is notified to the searching section 15. The searching section 15 displays a list of the corresponding business process data at the step S2 in order of higher estimation value Wn, as shown in FIG. 11. Also, the estimation value Wn itself is related to the business process data and displayed. Also, the searching section 15 displays a button to copy the displayed business process data.

### Step S8: Copy Instruction

It is supposed that the user selects one of the business process data displayed at the step S7 and clicks a copy button.

### Step S9: Copy and Register Business Process Data

In response to the click of the copy button, the copying section 14 copies the content of the selected business process data to generate new business process data. The copied data (content) includes a business process name, a task ID, a task execution order and a task name. With regard to a person in charge of the task, whether or not it is targeted for the copy is desired to be selected by the user. Also, the business process name is assumed to be changed even if the business process is the identical business. Thus, the business process name may be able to be changed after the copy. For example, when the business process name of the copy source is “proposal for X corporation customer”, the business process name of the new business process data can be changed to “proposal for Y corporation customer”. Also, the copying section 14 gives a new business process ID to the new business process data and registers in the business process data table.

Step S10: Register Relational data

Next, the copying section 14 relates the business process ID of the copy source to the new business process ID and stores as relational data in the relational data storage section 23.

By the processes until the above step S10, the new business process data is generated. The new business process data is hereinafter managed by the business process data managing section 16. Then, the progress situation of the task, and the change, addition and removal of the task are carried out.

Step S11: Business Completion notice

With regard to the new business process data, it is supposed that the completion of all tasks is reflected. That is, it is supposed that the user inputs the completion of all tasks through the input/output unit 300.

Step S12: Input of User Estimation data

Then, the user estimation inputting section 13 displays a display image for the user estimation input shown in FIG. 10 and urges an input of the estimation result. The input estimation result is stored in the user estimation data storage section 22, as mentioned above.

### Step S13: Determine Whether or Not Completed Business Process is a Copy

Also, in case of the completion of the business, the identical business process extracting section 12 refers to the relational data storage section 23. Then, the identical business process extracting section 12 determines whether the completed new business process data is generated by copying a different business process data or generated independently of the other business process data.

Step S14: Change Generation after Copy?

If it is determined at the step S13 that it is generated by copy, the identical business process extracting section 13 compares the task data of the new business process data with the task data of the business process data of the copy source. Then, whether or not the task data has been changed is determined. Specifically, the identical business process extracting section 13 checks whether or not the task execution order and the task name have been changed. Also, the identical business process extracting section 13 checks whether a new task has been added or a task has been removed.

### Step S15: Record ID of Copy Source as Identical Business Process ID

If any change has not been generated at the step S14, the identical business process extracting section 12 determines that the new business process data has substantially the same content as that of the business process data of the copy source. Then, as the identical business process ID of the new business process data, the ID identical to that of the business process data of the copy source is given.

### Step S16: Store Self Business Process ID as Identical Business Process ID

On the other hand, if it is determined at the step S13 that it is not the copy, the identical business process extracting section 13 determines that the new business process data is new in the content. Then, the same data as its own business process ID is written to a column of the identical business process ID in the relational data. A case in which a change is carried out after the copy at the step S14, too, is similar.

As mentioned above, according to this exemplified embodiment, the identical business process extracting section 12 determines whether or not the new business process data and the business process data of the copy source are identical to each other. Thus, the identical business process extracting section 12 can collects the business process data with same contents, as the identical business process data group. As a result, even in the transient work process, it is possible to know the businesses with contents identical to each other. In addition, the estimation value Wn is calculated in units of the identical business process data groups. Therefore, even in the transient work process, it is possible to statistically estimate the past businesses.

Also, in this exemplified embodiment, the number of times of copy is reflected on the estimation value. Thus, even in the transient work process, it is possible to estimate the effectiveness of the business.

Also, in this exemplified embodiment, the estimation result by the user is reflected on the estimation value. That is, an element other than the number of times of copy can be reflected on the estimation value Wn of the business process data. Thus, it is possible to properly estimate the efficiency in the transient work process that cannot be simply estimated from a quantity of results.

Also, in this exemplified embodiment, the searching section 15 displays the business process data in order of higher estimation value Wn as the search result. That is, the business process data having the high estimation value Wn is preferentially provided as the search result to the user. Thus, it becomes easy to reuse the business process data having the high estimation value Wn (the excellent efficiency). Therefore, it becomes easy to employ the business process effective for the business to be newly started.

This exemplified embodiment will be described about a case where the identical business process extracting section 12 determines whether or not the content of the newly generated business process data is identical to that of the copy source. However, not only the determination of whether or not they are merely identical to each other but also the determination of the similarity may be carried out. For example, the identical business process extracting section 12 counts the number of change points of the task data in the new business process data. The identical business or the similar business or the different business is determined on the basis of the number of its change points. Then, in addition to the identical business process data group, the business process data that are similar to each other are collected as a similar business process data group. The estimation calculating section 11 calculates the estimation value Wn for each similar business process data group and notifies the calculation result to the user. Thus, even if the number of business process data included in the identical business process data group is small, the estimation value Wn for the past businesses can be calculated at a high reliability.

It should be noted that this exemplified embodiment will be described about the example in which the searching section 15 urges the user to input a keyword and then the retrieval is carried out on the basis of the input keyword. However, the searching section 15 can carry out the retrieval by using the other method. For example, a tag to classify the field of the business is given to the business process data. Then, when the tag is inputted by the user, the business process data of the corresponding field may be retrieved.

This application is claims a priority on convention based on Japanese Patent Application NO. 2008-121985. The disclosure thereof is incorporated herein by reference.

1. A business process control apparatus comprising:
a business process data storage section configured to store a business process data group;
a copying section configured to copy business process data contained in said business process data group and add new business process data to said business process data group;
a business process data managing section configured to change a content of said new business process data in response to an instruction from a user; and
an identical process data extracting section configured to extract said business process data having same content from said business process data group as an identical business process data group,
wherein said identical process data extracting section extracts said identical business process data group based on whether or not said new business process data has the same content as said business process data of a copy source.

2. The business process control apparatus according to claim 1, further comprising:
a relational data storage section configured to store correspondence relation between said new business process data and said copy source business process data as relational data,
wherein said identical business process data extracting section specifies said copy source business process data to said new business process data based on said relational data.

3. The business process control apparatus according to claim 2, wherein said copying section generates said relational data when copying said business process data and stores said relational data in said relational data storage section.

4. The business process control apparatus according to claim 1, wherein said business process data comprises data of a name of a business process or a name of a person in charge, and
wherein said identical business process extracting section compares said new business process data and said copy source business process data with respect to the contents regardless of the name of the business process or the name of the person in charge.

5. The business process control apparatus according to claim 1, further comprising:
an estimation calculating section configured to calculate an estimation value indicating how much said business process data is effective.

6. The business process control apparatus according to claim 5, wherein said estimation calculating section calculates said estimation value based on the number of times of copy of said business process data by said copying section.

7. The business process control apparatus according to claim 5, wherein said estimation calculating section calculates said estimation value in units of said identical business process data groups.

8. The business process control apparatus according to claim 5, further comprising:
a searching section configured to search said business process data from said business process data group based on data for search inputted from the user, and notifying to the user, a list of the searched business process data in an order determined based on said estimation values.

9. The business process control apparatus according to claim 5, further comprising:
a user estimation data storage section configured to store correspondence relation between said business process data and an estimation result by the user as user estimation data,
wherein said estimation calculating section calculates said estimation value based on the estimation result by the user.

10. A business process control method comprising:
storing business process data group by a computer;
copying business process data contained in said business process data group to add new business process data to said business process data group, by said computer;
changing a content of said new business process data in response to an instruction from a user; and
extracting said business process data having same contents from said business process data group as an identical business process data group by said computer,
wherein said extracting comprises:
extracting said identical business process data group by comparing the content of said new business process data and that of said business process data of a copy source.

11. The business process control method according to claim 10, further comprising:
storing correspondence relation between said new business process data and said copy source business process data as relational data by a computer, and
wherein said extracting comprises:
specifying said copy source business process data to said new business process data based on said relational data.

12. The business process control method according to claim 10, wherein said business process data comprises data of a name of a business process or a name of a person in charge, and
wherein said extracting comprises:
comparing said new business process data and said copy source business process data with respect to the contents regardless of the name of the business process or the name of the person in charge.

13. The business process control method according to claim 10, further comprising:
calculating an estimation value indicating how much said business process data is effective, based on the number of times of copy of said business process data by said computer.

14. The business process control method according to claim 13, further comprising:
searching said business process data from said business process data group based on data for search inputted from the user, by said computer; and
notifying to the user, a list of the searched business process data in an order determined based on said estimation values, by said computer.

15. The business process control method according to claim 13, further comprising:
storing correspondence relation between said business process data and an estimation result by the user as user estimation data by said computer,
wherein said calculating an estimation value comprises:
calculating said estimation value based on the estimation result by the user.

16. A computer-readable recording tangible medium in which a computer-executable program code is stored to attain a business process control method which comprises:
storing business process data groups;
copying business process data contained in said business process data group in response to an instruction from the user; and
adding new business process data to said business process data group, by said computer;
changing a content of said new business process data in response to an instruction from a user; and
extracting said business process data having same contents from said business process data group as an identical business process data group,
wherein said extracting comprises:
extracting said identical business process data group by comparing the content of said new business process data and that of said business process data of a copy source.

17. The computer-readable recording tangible medium according to claim 16, further comprising:
storing correspondence relation between said new business process data and said copy source business process data as relational data by a computer, and
wherein said extracting comprises:
specifying said copy source business process data to said new business process data based on said relational data.

18. The computer-readable recording tangible medium according to claim 16, wherein said business process data comprises data of a name of a business process or a name of a person in charge, and
wherein said extracting comprises:
comparing said new business process data and said copy source business process data with respect to the contents regardless of the name of the business process or the name of the person in charge.

19. The computer-readable recording tangible medium according to claim 16, further comprising:
calculating an estimation value indicating how much said business process data is effective, based on the number of times of copy of said business process data.

20. The computer-readable recording tangible medium according to claim 19, further comprising:
searching said business process data from said business process data group based on data for search inputted from the user; and
notifying to the user, a list of the searched business process data in an order determined based on said estimation values.

21. (canceled)
